(19) United States
(12) Patent Application Publication
(10) Pub. No.: US 2022/0275470 A1
(43) Pub. Date: Sep. 1, 2022

(54) HIGH-MAGNETIC-INDUCTION ORIENTED SILICON STEEL AND MANUFACTURING METHOD THEREFOR

(71) Applicant: BAOSHAN IRON & STEEL CO., LTD., Shanghai (CN)

(72) Inventors: Huabing ZHANG, Shanghai (CN); Guobao LI, Shanghai (CN); Kanyi SHEN, Shanghai (CN); Baojun LIU, Shanghai (CN); Changjun HOU, Shanghai (CN); Xinqiang ZHANG, Shanghai (CN); Jianbing CHEN, Shanghai (CN); Meihong WU, Shanghai (CN); Changsong MA, Shanghai (CN); Desheng LIU, Shanghai (CN)

(73) Assignee: BAOSHAN IRON & STEEL CO., LTD., Shanghai (CN)

(21) Appl. No.: 17/631,693

(22) PCT Filed: Aug. 11, 2020
(86) PCT No.: PCT/CN2020/108333

§ 371 Date: Jan. 31, 2022

(30) Foreign Application Priority Data
Aug. 13, 2019 (CN) 201910743291.6

(51) Int. Cl. C21D 9/46; C21D 8/12; C22C 38/26; C22C 38/20; C22C 38/06; C22C 38/04; C22C 38/02; C22C 38/00; H01F 1/147; H01F 41/02

(52) U.S. Cl. CPC C21D 9/46; C21D 8/1222; C21D 8/1233; C21D 8/1255; C21D 8/1283; C22C 38/26; C22C 38/20; C22C 38/06; C22C 38/04; C22C 38/02; C22C 38/008; C22C 38/002; C22C 38/001; H01F 1/14775; H01F 41/0233; C21D 2201/05; C22C 2202/02

(57) ABSTRACT

Disclosed is a high-magnetic-induction oriented silicon steel, wherein the chemical elements thereof are, in mass percentage: Si: 2.0-4.0%; C: 0.03-0.07%; Al: 0.015-0.035%; N: 0.003-0.010%; Nb: 0.0010-0.0500%, the balance being Fe and inevitable impurities. The manufacturing method for the high-magnetic-induction oriented silicon steel includes the steps of: (1) smelting and casting; (2) heating a slab; (3) hot rolling; (4) cold rolling; (5) decarbonizing and annealing; (6) nitriding treatment; (7) applying an MgO coating; (8) high temperature annealing; and (9) applying an insulating coating; wherein a high-magnetic-induction oriented silicon steel is obtained by the manufacturing method, having an average primary grain size of 14-22 μm and a primary grain size variation coefficient of higher than 1.8; and wherein

$$the primary grain size variation coefficient = \frac{\begin{matrix}the average primary \\ grain size\end{matrix}}{\begin{matrix}standard deviation of a \\ primary grain size\end{matrix}} .$$

### TECHNICAL FIELD

The present disclosure relates to a steel grade and a manufacturing method therefor, in particular to oriented silicon steel and a manufacturing method therefor.

### BACKGROUND

Oriented silicon steel is an indispensable soft magnetic material in electric power and national defense industries, which is composed of grains with Goss texture. Its Goss texture is expressed as {110} <001> with a Miller index. The {110} crystal plane of the grains is parallel to the rolling plane, and the <001> crystal orientation of the grains is parallel to the rolling direction. Thus, the oriented silicon steel has the best easy magnetization performance under an oriented magnetic field, and makes full use of magnetocrystalline anisotropy to realize the best magnetic properties of polycrystalline materials. When the iron core of the power transformer or the transmission transformer is made of oriented silicon steel, due to its extremely high magnetic induction and extremely low iron loss, materials and electric energy can be significantly saved under the working condition of directional magnetic field. Iron loss P_{17/50} and magnetic induction B₈ are usually used to characterize the magnetic performance level of the oriented silicon steel, wherein P_{17/50} represents the iron loss per kg specimen when the maximum magnetic induction intensity is 1.7 T and the frequency is 50 Hz; and B₈ represents the magnetic induction intensity corresponding to a magnetic field strength of 800 A/m.

According to the magnetic induction B₈, oriented silicon steels can be divided into two categories: ordinary oriented silicon steels (B₈<1.88 T) and high magnetic induction oriented silicon steels (B₈≥1.88 T). Traditional high magnetic induction oriented silicon steels are produced with a high temperature slab heating process, which has the following drawbacks: in order to make the inhibitor fully dissolve, the slab heating temperature usually needs to reach 1400° C., which is a limit level of the traditional heating furnace. In addition, due to the high temperature for heating slabs, the utilization rate of the heating furnace is low, the service life is short, the silicon segregates at grain boundaries, the hot crimping crack is serious, the yield is low, the energy consumption is large, and the manufacturing cost is high.

In view of the above defects, more and more researches focus on how to reduce the heating temperature of the oriented silicon steel. At present, according to temperature range of heating slabs, there are two main improvement paths: one is medium temperature slab heating process, wherein the temperature for heating slabs is 1250 to 1320° C., and AlN and Cu₂S are used as inhibitors; the other is low temperature slab heating process, wherein the temperature for heating slabs is 1100 to 1250° C., and the inhibitor is introduced by nitridation in the later process. Among them, the low temperature slab heating process is widely used because it can produce high magnetic induction oriented silicon steel at low cost.

However, the main difficulty of the low temperature slab heating process lies in the selection of inhibitors and morphology control. The low temperature slab heating process has obvious advantages in manufacturing cost and yield, but compared with the high temperature slab heating process, there is a significant increase in unstable factors of inhibitors. For example, coarse precipitates formed during casting, such as MnS+AlN composite precipitates with TiN as the core, are difficult to dissolve in subsequent annealing; the inhibition effect of the inhibitors decreases, which makes it more difficult to control the primary grain size; and there may be some problems such as uneven distribution of nitridation amount, which leads to uneven distribution of inhibitors AlN, (Al, Si) N, (Al, Si, Mn) formed by nitrogen diffusion during high temperature annealing, and it is reflected in the product quality as uneven magnetic properties along the sheet width and roll length. Compared with the high temperature production process, the low temperature slab heating process requires that the content range of inhibitor-forming elements such as Als be controlled to the ppm level; it has strict requirements on the primary grain size and nitridation amount after decarbonizing and annealing; and it has high requirements on manufacturing process and technical equipment. Due to the significant increase in technical difficulty, a typical magnetic induction B₈ of high magnetic induction oriented silicon steel produced by low temperature slab heating process is between 1.88 T and 1.92 T, which is lower than that of similar products produced by high temperature processes, and the incidence of defects such as oxide film is relatively high.

Some improved processes for low temperature slab heating focus on further increase of the product grade, such as strip steel thickness thinning, silicon content increasing, magnetic domain refining by grooving, rapid induction heating, etc., and these techniques increase investment or manufacturing costs somewhat for high quality. Other improved processes focus on reducing the inhibitor element content from steelmaking sources and optimizing the heat treatment process to further reduce manufacturing costs, and some examples are given below.

CN1708594A (published on Dec. 14, 2005, “Method for producing grain oriented magnetic steel sheet and grain oriented magnetic steel sheet”) discloses an invention which can be considered as a method for manufacturing high-magnetic-induction oriented silicon steel, which is a “inhibitor-free method”. In the invention disclosed in this patent document, the slab composition includes, by mass percentage, 0.08% or less of C, 2.0%-8.0% of Si, 0.005%-3.0% of Mn, and 100 ppm or below of Al; further, N, S and Se are respectively 50 ppm or below, and the balance is Fe and inevitable impurities. A nitridation operation is not carried out during cold rolled slab annealing. The slab heating temperature can be reduced to 1250° C. or below. The manufacturing cost of the high temperature annealing process can also effectively reduced due to low contents of C, N, S, Se and Al. Although the manufacturing process described above is simple and has reduced manufacturing costs, the product grade is not high and the magnetic properties are not stable, and the magnetic induction B₈ is lower than 1.91 T in all examples. In order to solve the problem of the unstable magnetic properties of the inhibitor-free method, additional improved processes are required, which will inevitably increase the manufacturing costs.

CN101573458A (published on Nov. 4, 2009, “Method for manufacturing grain-oriented electrical steel sheets with excellent magnetic property and high productivity”) discloses an invention being a high-magnetic-induction oriented silicon steel manufacturing method, which may be referred to as a “Low Temperature Slab Semi-Solid Solution Nitridation Method”. In the invention disclosed in this patent document, the slab composition includes C: 0.04-0.07%, Si: 2.0-4.0%, P: 0.02-0.075%, Cr: 0.05-0.35%, acid soluble Al: 0.020-0.040%, Mn: lower than 0.20%, N: lower than 0.0055%, S: lower than 0.0055% by mass, and the balance of Fe and inevitable impurities. This invention heats the slab to a temperature at which the precipitates in the slab are partially dissolved, and it requires that the amount of N dissolved by the slab heating process is between 0.0010% and 0.0040%. Then, the slab is hot rolled, annealed, cold rolled, decarbonized and nitrided simultaneously in a mixed atmosphere of ammonia, hydrogen and nitrogen, and then annealed at high temperature to obtain the finished product. This invention controls the content of N and S in the slab at a low level, controls the amount and morphology of the effective inhibitor, and achieves an average primary grain size of 18-30 μm, which can drastically shorten the high temperature annealing time while obtaining excellent magnetic properties. For this invention, the de-S loading during the high temperature annealing can be mitigated due to the lower S content, but it is practically difficult to substantially shorten the purifying annealing time during the high temperature annealing in view of the nitridation annealing treatment of the cold rolled slab. Furthermore, to control the amount of N dissolved by the slab heating process, it is also required that the temperature for heating slabs be 1050-1250° C.

It is often difficult to improve the product grade of oriented silicon steel and reduce the manufacturing costs at the same time. In the above-mentioned patent documents, the difficulty lies in how to stably realize the high-level matching of driving force and inhibitory force of secondary recrystallization. Generally, decrease of inhibitor element contents will reduce the inhibitory force necessary for primary recrystallization and secondary recrystallization, which leads to an increase and non-uniformity of the primary grain size and the increase of secondary recrystallization temperature. If the average primary grain size is too large, the driving force of secondary recrystallization will be reduced and the secondary nucleus will be reduced; if the primary grain size is not uniform, non-Gauss grains will undergo secondary recrystallization; and if the secondary recrystallization temperature increases, it means that the heating time before secondary recrystallization increases, which increases the risk of coarsening or oxidation of inhibitors. All of these will cause the magnetic performance of finished products to be degraded or even scrapped. Due to the fact that magnetic properties are difficult to be stably controlled, some existing technologies reduce the manufacturing cost by changing the morphology of inclusions precipitated from the slabs, and some examples are given below.

CN103805918A (published on May 21, 2014, “High-magnetic induction oriented silicon steel and production method thereof”) discloses a high-magnetic-induction oriented silicon steel and a manufacturing method therefor. In the invention disclosed in this patent document, the slab composition includes C: 0.035-0.120%, Si: 2.5-4.5%, Mn: 0.05-0.20%, S: 0.005-0.050%, Als: 0.015-0.035%, N: 0.003-0.010%, Sn: 0.03-0.30%, and Cu: 0.01-0.50% by mass. By controlling the contents of trace elements (V: lower than 0.0100%, Ti: lower than 0.0100%, Sb+Bi+Nb+Mo: 0.0025-0.0250%, and (Sb/121.8+Bi/209.0+Nb/92.9+Mo/95.9)/(Ti/47.9+V/50.9)=0.1-15), the amount of coarse precipitates in the slab can be greatly reduced, and the heating temperature of the slab can be reduced by 100 to 150° C. If the cold rolled slab is not nitrided, the heating temperature of the slab is 1200-1330° C.; and if the cold rolled sheet is nitrided, the heating temperature of the sheet can be further reduced to 1050-1150° C.

### SUMMARY

One of the objectives of this disclosure is to provide a high-magnetic-induction oriented silicon steel. By designing the chemical composition of the silicon steel, the amount of the secondary inhibitors was ensured, the precipitate morphology of the primary inhibitors was finer and more dispersed, the primary grain size was more uniform, and then a high-level matching between the primary grain size and the inhibitors during the secondary recrystallization was achieved. As a result, the finished products of the finally obtained high-magnetic-induction oriented silicon steels had sharp Goss texture and excellent magnetic properties, and the manufacturing cost could be further reduced.

In order to achieve the above objectives, the present disclosure provides a high-magnetic-induction oriented silicon steel, comprising the following chemical elements in mass percentage:

Si: 2.0-4.0%;

C: 0.03-0.07%;

Als: 0.015-0.035%;

N: 0.003-0.010%;

Nb: 0.0010-0.0500%; and

the balance being Fe and inevitable impurities.

Through spectroscopic analysis of coarse MnS+AlN composite inclusions precipitated in the prior art, the inventors have found that the size of MnS+AlN composite inclusions is in the range of 0.5-3.0 μm. However, the size of AlN precipitated alone is typically lower than 400 nm. Thus, it can be seen that the MnS+AlN composite inclusions significantly increase the difficulty of tuning inhibitor morphology and are not conducive to obtaining excellent magnetic properties.

Based on this discovery, the present inventors optimized the steel composition. By controlling the contents of Als, N and Nb elements to improve the precipitation conditions of AlN, AlN was preferentially attached to Nb (C, N) instead of MnS precipitates, the precipitation amount of MnS+AlN composite precipitates was reduced, and the precipitation of fine AlN dispersions as the primary inhibitors was promoted. Thus, the magnetic properties were improved, so that oriented silicon steel with magnetic induction B₈>1.93 T can be obtained. Because of the decrease of S content in the slab and the improvement of primary inhibitor morphology, the manufacturing costs of inhibitor morphology adjustment and subsequent steps such as high temperature purification annealing can be obviously reduced.

It should be noted that inhibitors utilize fine precipitates with good thermal stability. In the technical field, inhibitors include manganese sulfide (MnS), copper sulfide (Cu₂S) and aluminium nitride (AlN), and some segregation elements such as Sn and P can also be used as auxiliary inhibitors. When selecting inhibitors, the effect of MnS which has a high solid solution temperature should be weakened as much as possible. In addition, compared with MnS and Cu₂S, AlN precipitates are finer and have better inhibition effect, thus AlN was used as the main inhibitor. Inhibitors can be subdivided into primary inhibitors and secondary inhibitors according to the source of acquisition. The primary inhibitors are derived from the existing precipitates in the slabs, wherein these precipitates are formed during steelmaking and casting, partially dissolved during heating slabs and precipitated during rolling, and the morphology of precipitates was adjusted by annealing the hot-rolled slab, which have an important influence on the primary recrystallization and thus affect the magnetic properties of final products. The secondary inhibitors are mainly derived from nitriding treatment after decarbonizing and annealing, during which nitrogen combines with the original aluminium in the steel to form fine dispersed particles such as AlN, (Al, Si) N, (Al, Si, Mn) N, etc. During high temperature annealing, secondary inhibitors and primary inhibitors jointly promote secondary recrystallization. When the driving force determined by primary grain size matches the inhibitory force determined by the inhibitors, the Goss texture of secondary recrystallization was sharp, and the final products had excellent magnetic properties.

In addition, the design principle for each chemical element of the high-magnetic-induction oriented silicon steel is as follows:

Si: In the high-magnetic-induction oriented silicon steel described herein, Si is a base element of the oriented silicon steel, which can increase resistivity and reduce iron loss. If the mass percentage of Si is lower than 2.0%, the resistivity drops and the eddy current loss of the oriented silicon steel is not effectively reduced; however, if the mass percentage of Si is higher than 4.0%, Si has a tendency to segregate along grain boundaries, which not only increases the brittleness of the steel sheet and deteriorates the rollability, but also destabilizes the recrystallized structure and inhibitors, resulting in incomplete secondary recrystallization. Based on the above reasons, the mass percentage of Si defined in the high-magnetic-induction oriented silicon steel of the present disclosure is in the range of 2.0-4.0%.

C: In the high-magnetic-induction oriented silicon steel described herein, the C content is to be matched with the Si content to ensure that a proper proportion of γ phase is obtained during the hot rolling process. If the mass percentage of C is lower than 0.03%, the γ phase proportion of the hot rolling process is low, which is not conducive to the formation of a uniform fine hot rolling texture by phase change rolling; however, if the mass percentage of C is higher than 0.07%, coarse carbide particles occur, which are difficult to remove during the decarbonization process, thus reducing the decarbonization efficiency and increasing the decarbonization cost. Based on the above reasons, the mass percentage of C in the high-magnetic-induction oriented silicon steel described herein is defined to be in the range of 0.03%-0.07%.

Als: The mass percentage of Als (acid soluble Al) in the high-magnetic-induction oriented silicon steel described herein is defined to be in the range of 0.015-0.035% because: Als can form secondary inhibitors in the subsequent nitriding treatment, and secondary inhibitors co-act with primary inhibitors to form sufficient pinning strength to promote secondary recrystallization. Considering that when the mass percentage of Als is lower than 0.015%, it results in insufficient pinning strength of the inhibitors and some non-favorable textures may also undergo secondary recrystallization, resulting in deterioration of magnetic properties or even no occurrence of secondary recrystallization; and if the mass percentage of Als is higher than 0.035%, the nitride of the Als coarsens and the inhibitor effect decreases. Based on the above reasons, the mass percentage of Als is defined to be in the range of 0.015 to 0.035% in the technical solution of the present disclosure.

N: In the high-magnetic-induction oriented silicon steels described herein, by controlling the mass percentage of N between 0.0030% and 0.0100%, a suitable amount of primary inhibitor AlN can be formed such that the pinning strength of the primary inhibitor is matched with the decarbonizing and annealing temperature, resulting in a fine uniform primary grain size. The main purpose of adding N in steel is to control the primary grain size stably, as N forms nitrides in the form of AlN and the like, being the element that forms the primary inhibitor. If the mass percentage of N is lower than 0.0030%, the primary inhibitor amount is insufficient, which is not conducive to the formation of fine and uniform primary grain sizes; but when the mass percentage of N exceeds 0.0100%, the cold rolled steel sheet is prone to bubble-like defects and the steelmaking load is increased. Based on the above reasons, in the technical solution of the present disclosure, the mass percentage of N is defined to be in the range of 0.003 to 0.010%.

Nb: In the high-magnetic-induction oriented silicon steel described herein, Nb is an effective microalloying element for grain refinement that can promote the formation of fine and uniform primary grain sizes, and the formed Nb (C, N) can also act as auxiliary inhibitors, thus reducing the difficulty of tuning the primary inhibitor morphology. If the mass percentage of Nb is lower than 0.0010%, the above effects cannot be effectively exerted; but if the mass percentage of Nb exceeds 0.0500%, it will exhibit a strong preventive effect on recrystallization, resulting in incomplete secondary recrystallization. Therefore, in the high-magnetic-induction oriented silicon steel described herein, the mass percentage of Nb is defined to be in the range of 0.0010-0.0500%.

Further, in the high-magnetic-induction oriented silicon steel described herein, the steel further comprises at least one of the following chemical elements: Mn: 0.05-0.20%, P: 0.01-0.08%, Cr: 0.05-0.40%, Sn: 0.03-0.30%, and Cu: 0.01-0.40%.

Mn: In some preferred embodiments, Mn is added because: similar to Si, Mn can increase resistivity and reduce eddy current loss. In addition, Mn can also enlarge the γ phase zone, with the effect of improving hot-rolled plasticity and structure and thus improving hot-rolled rollability. However, if the mass percentage of the added Mn is lower than 0.05%, the above-mentioned effects cannot be effectively exerted; whereas if the mass percentage of the added Mn is higher than 0.20%, a mixed α-γ dual phase structure tends to occur to cause phase transformation stress and γ phase generation upon annealing, resulting in unstable secondary recrystallization. Based on the above reasons, in some preferred embodiments, the mass percentage of the added Mn is preferably set to be in the range of 0.05% to 0.20%.

P: In some preferred embodiments, P is added because: P is a grain boundary segregating element that acts as an auxiliary inhibitor. Even at a high temperature of about 1000° C., P still has the effect of grain boundary segregation during secondary recrystallization, which can retard the premature oxidative decomposition of AlN and is conducive to secondary recrystallization. However, if the mass percentage of P added is lower than 0.01%, the above effect cannot be effectively exerted. P can also significantly increase resistivity and reduce eddy current loss. However, if the mass percentage of P added is higher than 0.08%, not only the nitridation efficiency is decreased, but also the cold-rolled rollability is deteriorated. Based on the above reasons, in some preferred embodiments, the mass percentage of added P is preferably set to be in the range of 0.01-0.08%.

Cr: In some preferred embodiments, the addition of Cr increases electrical resistivity, is beneficial to improve mechanical properties, and can significantly improve bottom layer quality by promoting the oxidation of the steel sheet. In order to make full use of the effect of Cr, the mass percentage of added Cr can be higher than 0.05%, but given that when Cr is added higher than 0.40%, a dense oxide layer will be formed during the decarbonization process, resulting in affecting the decarbonization and nitridation efficiency. Based on the above reasons, in some preferred embodiments, the mass percentage of added Cr is preferably set to be in the range of 0.05 to 0.40%.

Sn: In some preferred embodiments, Sn is added because: Sn is a grain boundary segregating element that acts as a secondary inhibitor, which can compensate for the decrease of inhibitory force caused by the coarsening of AlN precipitates in cases where Si content is increased or strip steel thickness is reduced or the like. Sn can enlarge the process window and facilitates the stability of magnetic properties of finished products. If the mass percentage of Sn is lower than 0.03%, the above effects cannot be efficiently obtained; and if the mass percentage of Sn is higher than 0.30%, the decarbonization efficiency will be affected, the quality of the bottom layer will be deteriorated, magnetic properties will not be improved and manufacturing costs will increase. Thus, in some preferred embodiments, the mass percentage of Sn is preferably defined to be in the range of 0.03-0.30%.

Cu: In some preferred embodiments, Cu is added because: similar to Mn, Cu can enlarge the γ phase zone, helping to obtain fine AlN precipitates. In addition to enlarging the γ phase zone, Cu is preferentially combined with S to form Cu₂S than Mn, which has the effect of inhibiting the formation of MnS at a high solid solution temperature. If the mass percentage of Cu added is lower than 0.01%, it is not possible to exert its above-described effects; but if the mass percentage of Cu added is higher than 0.40%, the manufacturing costs will increase and the magnetic properties will not be improved. Therefore, in some preferred embodiments, the mass percentage of Cu is preferably set to be in the range of 0.01-0.40%.

Further, in the high-magnetic-induction oriented silicon steel of the present disclosure, S is lower than or equal to 0.0050%, V is lower than or equal to 0.0050%, and Ti is lower than or equal to 0.0050% among inevitable impurities.

S: In the technical solutions described herein, considering that S is an element for forming precipitates such as MnS and Cu₂S, it is generally believed that suitable precipitates such as MnS and Cu₂S are advantageous in suppressing primary grain size variation and the S content is controlled to be in the range of 0.0050-0.0120%. However, the present inventors have found through extensive experimental studies that by reducing the S content in the slab, the effect of suppressing primary grain size variation is better, the magnetic properties are improved, and the manufacturing cost can also be further reduced. Thus, preferably, the mass percentage of S is defined to be lower than or equal to 0.0050%.

V and Ti: V and Ti are commonly used microalloying elements of steels. The formation of VN after nitriding treatment of V affects secondary recrystallization, and thus is not conducive to magnetic properties. Because Ti preferentially precipitates as TiN, MnS precipitates depending on TiN, and then AlN precipitates depending on MnS, it is easy to form coarse MnS+AlN composite inclusions, which is also not conducive to magnetic properties. Furthermore, by reducing the content of Ti and V, harmful inclusions of TiN and VN in the finished products can also be reduced. Accordingly, in the technical solution described herein, the mass percentage of Ti is defined to be lower than or equal to 0.0050%, and the mass percentage of V is defined to be lower than or equal to 0.0050%.

Further, the high-magnetic-induction oriented silicon steel of the present disclosure has an iron loss P_{17/5}≤0.28+2.5×sheet thickness [mm] W/kg, and a magnetic induction B₈≥1.93 T.

Accordingly, another objective of the present disclosure is to provide a manufacturing method for the above-mentioned high-magnetic-induction oriented silicon steel, by which high-magnetic-induction oriented silicon steels with excellent magnetic properties can be obtained, and the manufacturing method has low manufacturing cost.

In order to achieve the above objectives, the present disclosure provides a method for manufacturing the high-magnetic-induction oriented silicon steel, including the steps of:

(1) smelting and casting;

(2) heating a slab;

(3) hot rolling;

(4) cold rolling;

(5) decarbonizing and annealing;

(6) nitriding treatment;

(7) Applying a MgO coating;

(8) high temperature annealing; and

(9) applying an insulating coating, temper rolling and annealing;

wherein a high-magnetic-induction oriented silicon steel is obtained by the manufacturing method, having an average primary grain size of 14-22 μm and a primary grain size variation coefficient of higher than 1.8, and wherein

$$the primary grain size variation coefficient = \frac{\begin{matrix}the average primary \\ grain size\end{matrix}}{\begin{matrix}standard deviation of a \\ primary grain size\end{matrix}} .$$

In the manufacturing method of the present disclosure, steel making can be performed, for example, by a converter or an electric furnace. After secondary refining and continuous casting of the molten steel, a slab is obtained. The slab obtained is heated. Since the morphology of inhibitors in the slab is improved and the solid solution of MnS or Cu₂S is not a concern, it is sufficient that the temperature and time for heating a slab can ensure a smooth hot rolling without particularly considering the solid solution amount of inhibitors.

It should be noted that, in the technical solutions of the disclosure, the size of MN as a primary inhibitor is finer and thus the pinning effect of inhibitors is better, so that the primary grain size is more uniform, which is conducive to achieving a high-level matching between the primary grain size and the inhibitors, and improves the magnetic properties of the final products.

Further, in the manufacturing method described herein, in the step (2), a heating temperature and a heating time for the slab are 1050-1250° C. and less than 300 min, respectively.

In some preferred embodiments, a temperature for heating a slab is 1050-1150° C. and a time for heating a slab is less than 200 min, thereby effectively reducing the manufacturing cost of the slab heating.

Further, in the manufacturing method described herein, in the step (4), the cold rolling has a reduction ratio of more than or equal to 85%.

Further, in the manufacturing method described herein, in the step (5), a temperature and a time for the decarbonizing and annealing are 800-900° C. and 90-170 s, respectively.

Further, in the manufacturing method described herein, in the step (6), infiltrated nitrogen content is 50 to 260 ppm.

Further, in the manufacturing method described herein, in the step (8), a temperature and a time for the high temperature annealing are 1050-1250° C. and 15-40 h, respectively.

The above technical solutions are based on the following considerations: if the temperature for high temperature annealing is lower than 1050° C., the annealing time will need to be extended, the production efficiency will be reduced, and the manufacturing cost will be increased, which is not conducive to reducing the manufacturing cost; however, if the temperature for high temperature annealing is higher than 1250° C., the defects of steel coils will be increased, the magnetic properties cannot be improved, and the equipment life will be reduced.

Since the primary grain size obtained by the present manufacturing method is more uniform, the temperature of the secondary recrystallization can be reduced, and since the S content is controlled at a low level, the temperature for high temperature annealing is preferably controlled at 1050 to 1200° C. and the time for high temperature annealing is 15 to 20 h.

Further, in the manufacturing method as described in any one of the present embodiments, the manufacturing method also comprises a hot-rolled slab annealing step between the step (3) and the step (4), wherein a temperature and a time for the hot-rolled slab annealing are 850-1150° C. and 30-200 s, respectively.

In the technical solutions, a hot-rolled slab annealing step may be provided between the step (3) and the step (4), and of course, in some embodiments, a hot-rolled slab annealing step may not be provided if the required magnetic properties are not high.

The following considerations were made: if the temperature for hot-rolled slab annealing is lower than 850° C., the structure of the hot-rolled slab cannot be adjusted, and the morphology of the AlN inhibitor cannot be effectively adjusted; however, if the temperature for hot-rolled slab annealing is higher than 1150° C., the grains of the hot-rolled slab after annealing will be coarsened, which is not conducive to primary recrystallization. In addition, if the time for hot-rolled slab annealing is less than 30 s, the annealing time is too short to effectively adjust the morphology of AlN inhibitor and the structure of hot-rolled slab, and the effect of improving magnetic properties cannot be achieved; however, if the time for hot-rolled slab annealing is more than 200 s, the production efficiency will be reduced and the magnetic properties cannot be improved. Likewise, in the present disclosure, the number of coarse MnS+AlN composite inclusions in hot rolling is reduced, thus the difficulty of adjusting the morphology of the AlN inhibitor by hot-rolled slab annealing process can be reduced.

In some preferred embodiments, the temperature for hot-rolled slab annealing is preferably in the range of 850-1100° C. and the time for hot-rolled slab annealing is preferably in the range of 30-160 s.

The high-magnetic-induction oriented silicon steel and the manufacturing method therefor described herein have the following advantages and benefits over the prior art:

Through the design of chemical composition of silicon steel, the amount of the secondary inhibitors was ensured, the precipitate morphology of the primary inhibitors was finer and more dispersed, the primary grain size was more uniform, and then a high-level matching between the primary grain size and the inhibitors during the secondary recrystallization was achieved. As a result, the finished products of the finally obtained high-magnetic-induction oriented silicon steels had sharp Goss texture and excellent magnetic properties, and the manufacturing cost could be further reduced.

Furthermore, the manufacturing method described herein also has the above-mentioned advantages and benefits.

### BRIEF DESCRIPTION OF THE DRAWINGS

FIG. 1 shows the morphology of coarse MnS+AlN composite inclusions obtained with the prior art.

### DETAILED DESCRIPTION

The high-magnetic-induction oriented silicon steel and its manufacturing method described herein will be further explained and described below with reference to the accompanying drawings and specific examples. However, the present disclosure is not limited to them.

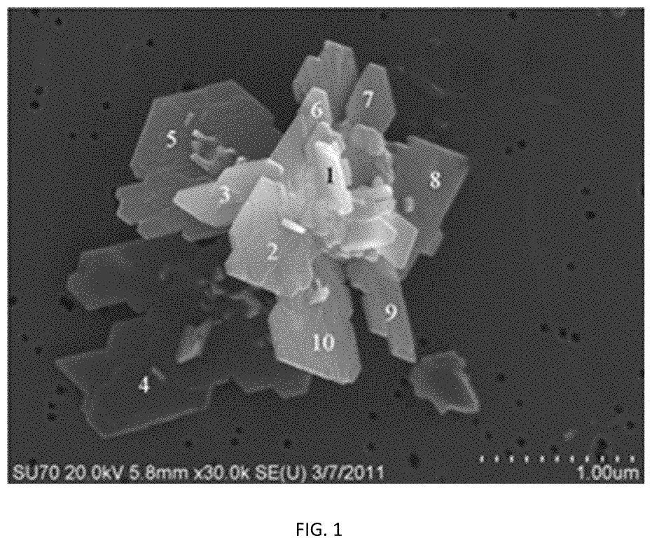

FIG. 1 shows the morphology of coarse MnS+AlN composite inclusions obtained with the prior art.

As shown in FIG. 1, in the prior art, the size of the precipitated coarse MnS+composite inclusions was between 0.5-3.0 μm. According to the spectroscopic results, the elements at position 1 as indicated in the FIGURE are mainly elements Mn, S and Ti, and the elements at positions 2, 3, 4, 5, 6, 7, 8, 9 and 10 as indicated in the FIGURE are elements Al and N. Typically, the size of AlN precipitated separately is less than 400 nm. Thus, it is suggested that coarse MnS+AlN composite inclusions can significantly increase the difficulty of adjusting the morphology of inhibitors, which is not conducive to obtaining excellent magnetic properties.

Based on the above findings, the present inventors believe that the precipitation conditions of AlN can be improved by controlling the contents of elements such as Als, N, S, Ti, V and Nb, such that AlN is preferentially attached to Nb (C, N) instead of MnS precipitates. Therefore, the amount of coarse MnS+AlN composite inclusions precipitated is reduced, the finely dispersed precipitation of the primary inhibitor AlN is promoted, and the magnetic properties are improved. Thus, oriented silicon steels with a magnetic induction B₈>1.93 T can be obtained. Due to the decrease of S content in the slab and the improvement of the primary inhibitor morphology, the manufacturing cost of inhibitor morphology adjustment and high temperature purification annealing process can be obviously reduced.

Test Methods

1. Average Primary Grain Size and Standard Deviation of Primary Grain Size

The average primary grain size and the standard deviation of the average primary grain size were determined as follows: after obtaining the metallograph of primary grain size, the average primary grain size and the standard deviation of the average primary grain size were obtained through area method analysis.

2. P_{17/50} and B₈

P_{17/50} and B₈ were obtained by using “Methods of measuring the magnetic properties of electrical steel sheet (strip) by means of an Epstein frame” in accordance with the National Standard GB/T 3655.

### Examples A1-A11 and Comparative Examples B1-B7

High-magnetic-induction oriented silicon steels of Examples A1-A11 and comparative silicon steels of Comparative Examples B1-B7 were produced according to the following steps:

(1) smelting and casting: smelting with a converter or electric furnace and continuously casting into a slab according to the formulations as shown in Table 1;

(2) heating a slab: heating the slab at 1150° C. or below for 200 min;

(3) hot rolling: hot rolling the slab to a thickness of 2.3 mm;

(4) annealing: annealing the hot-rolled slab at a temperature of 1120° C. for 170 s, and then cooling;

(5) cold rolling: cold rolling to a finished product thickness of 0.29 mm with a cold rolling reduction ratio of 87.4%;

(6) decarbonizing and annealing: decreasing the [C] content in the steel slab to 30 ppm or below at a decarbonization temperature of 810-880° C. for a decarbonization time of 90-170 s;

(7) nitriding treatment: the infiltrated nitrogen content being set in the range of 131-210 ppm;

(8) applying a MgO coating: applying a MgO coating on the steel slab;

(9) high-temperature annealing: performing high-temperature purifying annealing under an atmosphere of 100% H₂ at a temperature of 1200° C. for 25 hours; and

(10) applying an insulating coating, temper rolling and annealing: after uncoiling, applying insulating coating, performing hot stretching, temper rolling and annealing, and obtaining a high-magnetic-induction oriented silicon steel.

Table 1 lists mass percentages of chemical elements in high-magnetic-induction oriented silicon steels of Examples A1-A11 and comparative silicon steels of the Comparative Examples B1-B7.

TABLE 1
(wt%, balance being Fe and other impurities except S, V, and Ti)

| No. | Si | C | Als | N | S | V | Ti | Nb | Mn | P | Cr | Sn | Cu |
|---|---|---|---|---|---|---|---|---|---|---|---|---|---|
| A1 | 3.06 | 0.041 | 0.0310 | 0.0085 | 0.0046 | 0.0015 | 0.0044 | 0.0064 | — | 0.02 | 0.05 | 0.28 | — |
| A2 | 3.46 | 0.060 | 0.0296 | 0.0066 | 0.0036 | 0.0008 | 0.0033 | 0.0069 | 0.12 | 0.06 | 0.10 | — | 0.33 |
| A3 | 3.17 | 0.055 | 0.0303 | 0.0092 | 0.0037 | 0.0037 | 0.0019 | 0.0029 | 0.16 | 0.05 | 0.38 | 0.03 | — |
| A4 | 3.17 | 0.048 | 0.0282 | 0.0064 | 0.0034 | 0.0010 | 0.0013 | 0.0084 | 0.11 | 0.03 | 0.26 | 0.12 | 0.19 |
| A5 | 3.35 | 0.055 | 0.0271 | 0.0085 | 0.0028 | 0.0006 | 0.0028 | 0.0046 | 0.12 | 0.01 | — | 0.05 | 0.20 |
| A6 | 3.16 | 0.053 | 0.0252 | 0.0054 | 0.0018 | 0.0014 | 0.0007 | 0.0053 | 0.06 | — | — | 0.07 | 0.31 |
| A7 | 3.67 | 0.069 | 0.0292 | 0.0075 | 0.0049 | 0.0004 | 0.0050 | 0.0145 | 0.05 | 0.04 | — | 0.09 | 0.23 |
| A8 | 3.93 | 0.064 | 0.0262 | 0.0063 | 0.0039 | 0.0007 | 0.0018 | 0.0487 | — | 0.02 | 0.24 | — | — |
| A9 | 3.17 | 0.050 | 0.0283 | 0.0064 | 0.0021 | 0.0016 | 0.0016 | 0.0012 | — | — | 0.18 | 0.14 | 0.07 |
| A10 | 3.26 | 0.051 | 0.0317 | 0.0096 | 0.0035 | 0.0009 | 0.0032 | 0.0201 | 0.19 | — | 0.24 | 0.27 | 0.03 |
| A11 | 2.38 | 0.035 | 0.0162 | 0.0054 | 0.0026 | 0.0003 | 0.0014 | 0.0246 | 0.09 | 0.08 | 0.23 | — | — |
| B1 | 3.18 | 0.046 | [symbol] | 0.0059 | 0.0036 | 0.0011 | 0.0012 | 0.0024 | 0.10 | — | 0.14 | 0.19 | — |
| B2 | 3.36 | 0.059 | 0.0303 | [symbol] | [symbol] | 0.0023 | 0.0021 | 0.0036 | 0.06 | 0.03 | 0.15 | 0.07 | — |
| B3 | 3.07 | 0.046 | 0.0293 | 0.0084 | [symbol] | 0.0043 | [symbol] | — | 0.10 | 0.04 | — | 0.15 | 0.15 |
| B4 | 3.26 | 0.056 | 0.0252 | 0.0074 | [symbol] | [symbol] | 0.0023 | 0.0074 | — | 0.02 | 0.36 | 0.09 | 0.05 |
| B5 | 3.19 | 0.051 | 0.0314 | [symbol] | 0.0026 | 0.0010 | 0.0008 | — | 0.17 | 0.07 | 0.08 | 0.08 | 0.35 |
| B6 | 3.37 | 0.059 | 0.0305 | 0.0085 | 0.0028 | 0.0026 | [symbol] | [symbol] | 0.08 | 0.05 | 0.23 | — | 0.20 |
| B7 | 3.57 | 0.068 | [symbol] | 0.0085 | 0.0019 | 0.0008 | 0.0043 | 0.0128 | 0.08 | 0.05 | 0.18 | 0.05 | 0.20 |

Table 2 lists average primary grain sizes, primary grain size variation coefficients and magnetic properties, P_{17/50} and B₈, of finished products involved in Examples A1-A11 and Comparative Examples B1-B7.

TABLE 2

| | Average | Primary grain | Decarbonization | Decarbonization | Infiltrated | P_{17/50} of fin- | B8 of |
|---|---|---|---|---|---|---|---|
| | primary grain | size variation | temperature | time | nitrogen | ished product | finished |
| No. | size (μm) | coefficient | (° C.) | (s) | content (ppm) | (W/Kg) | product (T) |
| A1 | 17.7 | 2.3 | 833 | 119 | 150 | 0.933 | 1.964 |
| A2 | 16.8 | 2.2 | 833 | 121 | 163 | 0.930 | 1.946 |
| A3 | 19.7 | 2.5 | 833 | 122 | 131 | 0.925 | 1.941 |
| A4 | 22.2 | 1.9 | 838 | 117 | 170 | 0.960 | 1.947 |
| A5 | 20.1 | 2.1 | 838 | 116 | 143 | 0.951 | 1.953 |
| A6 | 18.5 | 1.9 | 838 | 114 | 180 | 0.939 | 1.958 |
| A7 | 18.1 | 2.9 | 843 | 113 | 156 | 0.962 | 1.956 |
| A8 | 14.7 | 2.3 | 843 | 115 | 138 | 0.941 | 1.957 |
| A9 | 17.5 | 2.5 | 843 | 111 | 146 | 0.943 | 1.948 |
| A10 | 16.6 | 2.4 | 848 | 112 | 150 | 0.953 | 1.954 |
| A11 | 16.8 | 2.0 | 848 | 109 | 195 | 0.950 | 1.942 |
| B1 | [symbol] | 2.1 | 838 | 115 | 162 | 1.356 | 1.729 |
| B2 | [symbol] | [symbol] | 838 | 116 | 210 | 1.035 | 1.909 |
| B3 | 18.9 | [symbol] | 838 | 118 | 153 | 0.973 | 1.907 |
| B4 | 19.7 | [symbol] | 838 | 115 | 186 | 1.001 | 1.923 |
| B5 | 18.7 | [symbol] | 843 | 110 | 135 | 1.103 | 1.872 |
| B6 | [symbol] | [symbol] | 843 | 112 | 145 | 1.352 | 1.752 |
| B7 | 18.7 | 1.9 | 843 | 115 | 183 | 1.069 | 1.897 |

As can be seen from Tables 1 and 2, the steel sheets of the present Examples A1-A11, particularly some preferred embodiments, exhibited generally better magnetic properties, such as higher magnetic induction B₈ and lower iron loss P_{17/50}, due to the slab composition of Als, N, S, V, Ti and Nb, as well as the qualified average primary grain sizes and primary grain size variation coefficients.

### Examples A12-A14 and Comparative Examples B8-B13

The specific manufacturing steps for high-magnetic-induction oriented silicon steels of Examples A12-A14 and the comparative silicon steels of the Comparative Examples B8-B13 were as follows:

(1) smelting and casting: smelting with a converter or electric furnace and continuously casting into a slab according to the formulations as shown in Table 3;

(2) heating a slab: heating the slab at 1150° C. or below for 210 min;

(3) hot rolling: hot rolling the slab to a thickness of 2.6 mm;

(4) annealing: annealing the hot-rolled slab at a temperature of 1120° C. for 190 s, and then cooling;

(5) cold rolling: cold rolling to a finished product thickness of 0.27 mm with a cold rolling reduction ratio of 89.6%;

(6) decarbonizing and annealing: decreasing the [C] content in the steel slab to 30 ppm or below according to the decarbonization temperature and decarbonization time as shown in Table 3;

(7) nitriding treatment: the infiltrated nitrogen content being set in the range of 138-173 ppm;

(8) applying a MgO coating: applying a MgO coating on the steel slab;

(9) high-temperature annealing: performing high-temperature purifying annealing under an atmosphere of 100% H₂ at a temperature of 1200° C. for 25 hours; and

(10) applying an insulating coating, temper rolling and annealing: after uncoiling, applying insulating coating, performing hot stretching, temper rolling and annealing, and obtaining a finished product of oriented silicon steel.

It should be noted that, for example, for the slab composition “Table 1-Al” of Example A12 in Table 3, it means that Example A12 performs smelting with the same chemical element composition with Example Al in Table 1. The slab compositions of other Examples and Comparative Examples can be deduced by analogy and will not be repeated here.

TABLE 3

| | | Decarbonization | Decarbonization | Infiltrated | Average | Primary grain | P_{17/50} of fin- | B₈ of |
|---|---|---|---|---|---|---|---|---|
| | Slab | temperature | time | nitrogen | primary grain | size variation | ished product | finished |
| No. | composition | (° C.) | (s) | content (ppm) | size (μm) | coefficient | (W/Kg) | product (T) |
| A12 | Table 1-A1 | 830 | 160 | 173 | 20.2 | 2.0 | 0.870 | 1.947 |
| A13 | Table 1-A2 | 840 | 155 | 169 | 16.5 | 2.4 | 0.861 | 1.953 |
| A14 | Table 1-A3 | 845 | 140 | 154 | 17.5 | 1.9 | 0.849 | 1.954 |
| B8 | Table 1-A1 | 790 | 150 | 149 | [symbol] | 1.9 | 0.923 | 1.894 |
| B9 | Table 1-A2 | 790 | 145 | 138 | [symbol] | 2.2 | 1.280 | 1.746 |
| B10 | Table 1-A3 | 790 | 130 | 153 | [symbol] | 2.5 | 1.083 | 1.841 |
| B11 | Table 1-A1 | 830 | 190 | 138 | [symbol] | [symbol] | 1.022 | 1.756 |
| B12 | Table 1-A2 | 840 | 185 | 173 | [symbol] | [symbol] | 0.923 | 1.927 |
| B13 | Table 1-A3 | 845 | 180 | 156 | [symbol] | 2.1 | 0.913 | 1.918 |

As can be seen from Table 3, by adjusting the decarbonization temperature and decarbonization time, the high-magnetic-induction oriented silicon steels, having the qualified average primary grain sizes and primary grain size variation coefficients, of Examples A12-A14, have achieved superior magnetic properties, such as higher magnetic induction B₈ and lower iron loss P_{17/50}.

### Examples A15-A18 and Comparative Examples B14-B17

The specific manufacturing steps for high-magnetic-induction oriented silicon steels of Examples A15-A18 and comparative silicon steels of Comparative Examples B14-B17 were as follows:

(1) smelting and casting: smelting with a converter or electric furnace and continuously casting into a slab according to the formulations as shown in Table 4;

(2) heating a slab: heating the slab according to the parameters as shown in Table 4;

(3) hot rolling: hot rolling the slab to a thickness of 2.4 mm;

(4) annealing: annealing the hot-rolled slab at a temperature of 1100° C. for 150 s, and then cooling;

(5) cold rolling: cold rolling to a finished product thickness of 0.29 mm with a cold rolling reduction ratio of 87.9%;

(6) decarbonizing and annealing: decreasing the [C] content in the steel slab to 30 ppm or below at a decarbonization temperature of 840° C. for a decarbonization time of 150 s;

(7) nitriding treatment: the infiltrated nitrogen content being set in the range of 146-186 ppm;

(8) applying a MgO coating: applying a MgO coating on the steel slab;

(9) high-temperature annealing: performing high-temperature purifying annealing under an atmosphere of 100% H₂ at a temperature of 1200° C. for 20 hours; and

(10) applying an insulating coating, temper rolling and annealing: after uncoiling, applying insulating coating, performing hot stretching, temper rolling and annealing, and obtaining a finished product of oriented silicon steel.

TABLE 4

| | | Slab heating | Slab heat- | Average | Primary grain | Infiltrated | P_{17/50} of fin- | B₈ of |
|---|---|---|---|---|---|---|---|---|
| | Slab | temperature | ing time | primary grain | size variation | nitrogen | ished product | finished |
| No. | composition | (° C.) | (min) | size (μm) | coefficient | content (ppm) | (W/Kg) | product (T) |
| A15 | Table 1-A4 | 1250 | 260 | 18.4 | 2.8 | 183 | 0.948 | 1.951 |
| A16 | | 1150 | 180 | 19.3 | 2.4 | 176 | 0.941 | 1.954 |
| A17 | | 1050 | 260 | 18.1 | 2.6 | 153 | 0.959 | 1.943 |
| A18 | | 1050 | 180 | 17.6 | 2.5 | 163 | 0.947 | 1.951 |
| B14 | Table 1-B3 | 1250 | 260 | 20.1 | 2.5 | 186 | 0.964 | 1.937 |
| B15 | | 1150 | 180 | 19.2 | 1.9 | 175 | 0.987 | 1.923 |
| B16 | | 1050 | 260 | 21.7 | [symbol] | 146 | 1.075 | 1.901 |
| B17 | | 1050 | 180 | [symbol] | [symbol] | 172 | 1.084 | 1.906 |

As can be seen from Table 4, the high-magnetic-induction oriented silicon steels of Examples A15-A18 exhibited excellent magnetic properties even with reduced slab heating temperature or reduced slab heating time. However, the magnetic properties of the comparative silicon steels of Comparative Examples B14-B17 deteriorated to varying degrees when slab temperature decreased or slab heating time shortened, because the chemical elements used were not within the scope limited by the present disclosure.

### Examples A19-A22 and Comparative Examples B18-B21

The specific manufacturing steps for high-magnetic-induction oriented silicon steels of Examples A19-A22 and the comparative silicon steels of Comparative Examples B18-B21 were as follows:

(1) smelting and casting: smelting with a converter or electric furnace and continuously casting into a slab according to the formulations as shown in Table 5;

(2) heating a slab: heating the slab at 1120° C. or below for 210 min;

(3) hot rolling: hot rolling the slab to a thickness of 2.5 mm;

(4) annealing: annealing the hot-rolled slab according to the temperature and time as shown in Table 5, and then cooling;

(5) cold rolling: cold rolling to a finished product thickness of 0.23 mm with a cold rolling reduction ratio of 90.8%;

(6) decarbonizing and annealing: decreasing the [C] content in the steel slab to 30 ppm or below at a decarbonization temperature of 830° C. for a decarbonization time of 155 s;

(7) nitriding treatment: the infiltrated nitrogen content being set in the range of 133-182 ppm;

(8) applying a MgO coating: applying a MgO coating on the steel slab;

(9) high-temperature annealing: performing high-temperature purifying annealing under an atmosphere of 100% H₂ at a temperature of 1210° C. for 20 hours; and

(10) applying an insulating coating, temper rolling and annealing: after uncoiling, applying insulating coating, performing hot stretching, temper rolling and annealing, and obtaining a finished product of oriented silicon steel.

TABLE 5

| | | Hot-rolled slab | Hot-rolled | Average pri- | Primary grain | Infiltrated | P17/50 | B₈ of |
|---|---|---|---|---|---|---|---|---|
| | Slab | annealing | slab annealing | mary grain | size variation | nitrogen | of finished | finished |
| No. | composition | temperature (° C.) | time(s) | size (μm) | coefficient | content (ppm) | product (W/Kg) | product (T) |
| A19 | Table 1-A5 | 1150 | 200 | 16.5 | 3.2 | 146 | 0.814 | 1.949 |
| A20 | | 1100 | 160 | 18.9 | 2.1 | 165 | 0.809 | 1.950 |
| A21 | | 1050 | 140 | 17.6 | 2.8 | 157 | 0.825 | 1.947 |
| A22 | | 1000 | 140 | 18.1 | 2.5 | 182 | 0.814 | 1.938 |
| B18 | Table 1-B4 | 1150 | 200 | 15.6 | 2.1 | 133 | 0.856 | 1.929 |
| B19 | | 1100 | 160 | 17.1 | 2.1 | 156 | 0.898 | 1.912 |
| B20 | | 1050 | 140 | 18.7 | 1.9 | 135 | 1.032 | 1.897 |
| B21 | | 1000 | 140 | 21.8 | [symbol] | 168 | 1.041 | 1.819 |

It can be seen from Table 5 that the high-magnetic-induction oriented silicon steels of Examples A19-A22 exhibited excellent magnetic properties even when hot-rolled slab heating temperature was reduced or hot-rolled slab heating time was shortened. However, magnetic properties of comparative silicon steels of Comparative Example B18-B21 deteriorated to varying degrees when hot-rolled slab heating temperature was reduced or hot-rolled slab heating time was shortened.

### Examples A23-A30 and Comparative Examples B22-B33

The specific manufacturing steps for high-magnetic-induction oriented silicon steels of Examples A23-A30 and the comparative silicon steels of Comparative Examples B22-B33 were as follows:

(1) smelting and casting: smelting with a converter or electric furnace and continuously casting into a slab according to the formulations as shown in Table 6;

(2) heating a slab: heating the slab at 1120° C. or below for 210 min;

(3) hot rolling: hot rolling the slab to a thickness of 2.6 mm;

(4) annealing: annealing the hot-rolled slab at a temperature of 1100° C. for 160 s, and then cooling;

(5) cold rolling: cold rolling to a finished product thickness of 0.23 mm with a cold rolling reduction ratio of 91.2%;

(6) decarbonizing and annealing: decreasing the [C] content in the steel slab to 30 ppm or below at a decarbonization temperature of 835° C. for a decarbonization time of 155 s;

(7) nitriding treatment: the infiltrated nitrogen content being set in the range of 134-196 ppm;

(8) applying a MgO coating: applying a MgO coating on the steel slab;

(9) high-temperature annealing: performing high-temperature purifying annealing under an atmosphere of 100% H₂ according to the temperature and time as shown in Table 6; and

(10) applying an insulating coating, temper rolling and annealing: after uncoiling, applying insulating coating, performing hot stretching, temper rolling and annealing, and obtaining a finished product of oriented silicon steel.

TABLE 6

| | | High | High | Average | Primary | Infiltrated | Finished | P_{17/50} | B₈ of |
|---|---|---|---|---|---|---|---|---|---|
| | | temperature | temperature | primary | grain size | nitrogen | product | of finished | finished |
| | Slab | annealing tem- | annealing | grain size | variation | content | residual S | product | product |
| No. | composition | perature (° C.) | time (hr) | (μm) | coefficient | (ppm) | (ppm) | (W/Kg) | (T) |
| A23 | Table 1-A4 | 1250 | 15 | 15.3 | 2.6 | 182 | <10 | 0.797 | 1.939 |
| A24 | | 1200 | 15 | 18.3 | 2.7 | 183 | <10 | 0.798 | 1.937 |
| A25 | | 1150 | 20 | 18.6 | 1.9 | 183 | <10 | 0.802 | 1.938 |
| A26 | | 1050 | 20 | 14.9 | 3.0 | 171 | <10 | 0.809 | 1.937 |
| A27 | Table 1-A5 | 1250 | 15 | 18.8 | 2.5 | 155 | <10 | 0.775 | 1.945 |
| A28 | | 1200 | 15 | 19.6 | 2.2 | 186 | <10 | 0.790 | 1.948 |
| A29 | | 1150 | 20 | 20.4 | 2.9 | 179 | <10 | 0.792 | 1.947 |
| A30 | | 1050 | 20 | 19.3 | 2.3 | 147 | <10 | 0.794 | 1.947 |
| B22 | Table 1-B2 | 1250 | 15 | 17.8 | 2.3 | 145 | <10 | 0.821 | 1.926 |
| B23 | | 1200 | 15 | 21.5 | 1.7 | 138 | 15 | 0.832 | 1.917 |
| B24 | | 1150 | 20 | 19.7 | 1.9 | 146 | 13 | 0.853 | 1.908 |
| B25 | | 1050 | 20 | 16.7 | 1.2 | 176 | 31 | 1.136 | 1.751 |
| B26 | Table 1-B3 | 1250 | 15 | 21.1 | 2.1 | 134 | <10 | 0.817 | 1.919 |
| B27 | | 1200 | 15 | 16.6 | 1.3 | 194 | 15 | 0.816 | 1.920 |
| B28 | | 1150 | 20 | 17.6 | 1.4 | 190 | 14 | 0.873 | 1.876 |
| B29 | | 1050 | 20 | 14.9 | 1.9 | 196 | 21 | 1.256 | 1.651 |
| B30 | Table 1-B4 | 1250 | 15 | 20.6 | 1.3 | 191 | <10 | 0.838 | 1.922 |
| B31 | | 1200 | 15 | 17.8 | 2.0 | 184 | 17 | 0.841 | 1.908 |
| B32 | | 1150 | 20 | 20.4 | 1.9 | 157 | 16 | 1.093 | 1.756 |
| B33 | | 1050 | 20 | 18.3 | 1.6 | 146 | 19 | 1.183 | 1.751 |

As can be seen from Table 6, for the high-magnetic-induction oriented silicon steels of Examples A23-A30, the residual S content in the finished product was lower than 10 ppm and there were no significant differences in magnetic properties even if the high temperature purifying annealing temperature was reduced or high temperature purifying annealing time was shortened. However, magnetic properties of comparative silicon steels of Comparative Examples B22-B33 deteriorated to varying degrees when the high temperature purifying annealing temperature was reduced or the purifying annealing time was shortened, and the residual S content in the finished product was relatively higher.

### Examples A31-A33 and Comparative Examples B34-B37

The specific manufacturing steps for high-magnetic-induction oriented silicon steels of Examples A31-A33 and the comparative silicon steels of Comparative Examples B34-B37 were as follows:

(1) smelting and casting: smelting with a converter or electric furnace and continuously casting into a slab according to the formulations as shown in Table 7;

(2) heating a slab: heating the slab at 1100° C. or below for 180 min;

(3) hot rolling: hot rolling the slab to a thickness of 2.3 mm;

(4) cold rolling: cold rolling to a finished product thickness of 0.30 mm with a cold rolling reduction ratio of 87.0%;

(5) decarbonizing and annealing: performing decarbonizing and annealing according to the process parameters as shown in Table 7 to decrease the [C] content in the steel slab to 30 ppm or below;

(6) nitriding treatment: the infiltrated nitrogen content being set in the range of 131-192 ppm;

(7) applying a MgO coating: applying a MgO coating on the steel slab;

(8) high-temperature annealing: performing high-temperature purifying annealing under an atmosphere of 100% H₂ at a temperature of 1200° C. for 20 hours; and

(9) applying an insulating coating, temper rolling and annealing: after uncoiling, applying insulating coating, performing hot stretching, temper rolling and annealing, and obtaining a finished product of oriented silicon steel.

TABLE 7

| | | Decarbonization | Decarbonization | Average | Primary grain | Infiltrated | P_{17/50} of | B₈ of |
|---|---|---|---|---|---|---|---|---|
| | Slab | temperature | time | primary grain | size variation | nitrogen | finished | finished |
| No. | composition | (° C.) | (s) | size (μm) | coefficient | content (ppm) | product (W/Kg) | product (T) |
| A31 | Table 1-A6 | 820 | 140 | 20.8 | 2.0 | 192 | 0.995 | 1.911 |
| A32 | | 825 | 140 | 20.7 | 2.4 | 176 | 0.963 | 1.925 |
| A33 | | 830 | 160 | 19.3 | 1.9 | 184 | 0.984 | 1.922 |
| B34 | Table 1-B5 | 820 | 140 | [symbol] | [symbol] | 131 | 1.182 | 1.722 |
| B35 | | 825 | 140 | [symbol] | [symbol] | 168 | 1.274 | 1.615 |
| B36 | | 830 | 160 | [symbol] | [symbol] | 176 | 1.286 | 1.618 |
| B37 | | 835 | 160 | [symbol] | [symbol] | 150 | 1.306 | 1.516 |

As can be seen from the Table 7, for Examples A31-A33, even if hot-rolled slab annealing was not performed, high-magnetic-induction oriented silicon steels were also obtained by adjusting the average primary grain size. In contrast, for comparative silicon steels of Comparative Examples B34-B37 without hot-rolled slab annealing, the primary grain size was not uniform and magnetic properties were poor due to weak inhibitory force of primary inhibitors.

It should be noted that in the above examples,

$$primary grain size variation coefficient = \frac{\begin{matrix}average primary \\ grain size\end{matrix}}{\begin{matrix}standard deviation of \\ primary grain size\end{matrix}} .$$

As can be seen from the above, for high-magnetic-induction oriented silicon steels of the present disclosure, by designing the chemical composition of the silicon steel, the amount of the secondary inhibitors was ensured, the precipitate morphology of the primary inhibitors was finer and more dispersed, the primary grain size was more uniform, and then a high-level matching between the average primary grain size and the inhibitors during the secondary recrystallization was achieved. As a result, the finished products of the finally obtained high-magnetic-induction oriented silicon steels had sharp Goss texture and excellent magnetic properties, and the manufacturing cost could be further reduced.

In addition, the manufacturing method of the present disclosure also exhibited the advantages and beneficial effects as described above.

It should be noted that for the prior art part of protection scope of the present disclosure, it is not limited to the examples given in this application document. All the prior arts that do not contradict with the present disclosure, including but not limited to prior patent documents, prior publications, prior public use, etc., can be included in the protection scope of the present disclosure.

In addition, the combination of various technical features in the present disclosure is not limited to the combination described in the claims or the combination described in specific embodiments. All the technical features described in the present disclosure can be freely combined or combined in any way unless there is a contradiction between them.

It should also be noted that the above-listed Examples are only specific embodiments of the present disclosure. Apparently, the present disclosure is not limited to the above embodiments, and similar variations or modifications that are directly derived or easily conceived from the present disclosure by those skilled in the art should fall within the scope of the present disclosure.

1. A high-magnetic-induction oriented silicon steel, comprising the following chemical elements in mass percentage:
Si: 2.0-4.0%;
C: 0.03-0.07%;
Al: 0.015-0.035%;
N: 0.003-0.010%;
Nb: 0.0010-0.0500%; and
the balance being Fe and inevitable impurities.

2. The high-magnetic-induction oriented silicon steel as claimed in claim 1, characterized in that the high-magnetic-induction oriented silicon steel further comprises at least one of the following chemical elements: Mn: 0.05-0.20%, P: 0.01-0.08%, Cr: 0.05-0.40%, Sn: 0.03-0.30%, and Cu: 0.01-0.40%.

3. The high-magnetic-induction oriented silicon steel as claimed in claim 1, characterized in that S is lower than or equal to 0.0050%, V is lower than or equal to 0.0050%, and Ti is lower than or equal to 0.0050% among the inevitable impurities.

4. The high-magnetic-induction oriented silicon steel as claimed in claim 1, characterized in that the silicon steel has an iron loss P_{17/50} of lower than or equal to (0.28+2.5×t) W/kg, wherein t represents a sheet thickness in mm; and a magnetic induction B₈ of more than or equal to 1.93 T.

5. A manufacturing method for the high-magnetic-induction oriented silicon steel as claimed in claim 1, comprising the steps of:
(1) smelting and casting;
(2) heating a slab;
(3) hot rolling;
(4) cold rolling;
(5) decarbonizing and annealing;
(6) nitriding treatment;
(7) applying a MgO coating;
(8) high temperature annealing; and
(9) applying an insulating coating;
wherein a high-magnetic-induction oriented silicon steel is obtained by the manufacturing method, having an average primary grain size of 14-22 μm and a primary grain size variation coefficient of higher than 1.8; and
wherein
$$the primary grain size variation coefficient = \frac{\begin{matrix}the average primary \\ grain size\end{matrix}}{\begin{matrix}standard deviation of a \\ primary grain size\end{matrix}} .$$

6. The manufacturing method as claimed in claim 5, characterized in that in the step (2), a heating temperature and a heating time for the slab are 1050-1250° C. and less than 300 min, respectively.

7. The manufacturing method as claimed in claim 5, characterized in that in the step (4), the cold rolling has a reduction ratio of more than or equal to 85%.

8. The manufacturing method as claimed in claim 5, characterized in that in the step (5), a temperature and a time for the decarbonizing and annealing are 800-900° C. and 90-170 s, respectively.

9. The manufacturing method as claimed in claim 5, characterized in that in the step (6), infiltrated nitrogen content is 50-260 ppm.

10. The manufacturing method as claimed in claim 5, characterized in that in the step (8), a temperature and a time for the high temperature annealing are 1050-1250° C. and 15-40 h, respectively.

11. The manufacturing method as claimed in claim 5, characterized in that the manufacturing method also comprises a hot-rolled slab annealing step between the step (3) and the step (4), wherein a temperature and a time for the hot-rolled slab annealing are 850-1150° C. and 30-200 s, respectively.

12. The high-magnetic-induction oriented silicon steel as claimed in claim 2, characterized in that the silicon steel has an iron loss P_{17/50} of lower than or equal to (0.28+2.5×t) W/kg, wherein t represents a sheet thickness in mm; and a magnetic induction B₈ of more than or equal to 1.93 T.

13. The high-magnetic-induction oriented silicon steel as claimed in claim 3, characterized in that the silicon steel has an iron loss P_{17/50} of lower than or equal to (0.28+2.5×t) W/kg, wherein t represents a sheet thickness in mm; and a magnetic induction B₈ of more than or equal to 1.93 T.

14. The manufacturing method as claimed in claim 9, characterized in that the manufacturing method also comprises a hot-rolled slab annealing step between the step (3) and the step (4), wherein a temperature and a time for the hot-rolled slab annealing are 850-1150° C. and 30-200 s, respectively.

15. The manufacturing method as claimed in claim 10, characterized in that the manufacturing method also comprises a hot-rolled slab annealing step between the step (3) and the step (4), wherein a temperature and a time for the hot-rolled slab annealing are 850-1150° C. and 30-200 s, respectively.
